(19) United States
(12) Patent Application Publication
(10) Pub. No.: US 2016/0332194 A1
(43) Pub. Date: Nov. 17, 2016

(54) KINETICALLY CONTROLLED SOL-GEL DOPING METHOD

(71) Applicant: The Board of Regents of the University of Oklahoma, Norman, OK (US)

(72) Inventors: Wai Tak Yip, Norman, OK (US); Adam Campbell, Norman, OK (US); Qiong Lei, Los Angeles, CA (US)

(21) Appl. No.: 15/153,238

(22) Filed: May 12, 2016

Related U.S. Application Data
(60) Provisional application No. 62/160,177, filed on May 12, 2015.

(51) Int. Cl. B05D 3/10; C09D 4/06; B05D 3/04

(52) U.S. Cl. CPC B05D 3/107; B05D 3/0486; C09D 4/06; B05D 1/005

(57) ABSTRACT

A new kinetically-controlled sol-gel doping method in which a dopant is applied to a sol-gel material during the transition (gelation) phase, rather than before or after the transition phase to an alcogel.

### CROSS REFERENCE TO RELATED APPLICATIONS/INCORPORATION BY REFERENCE STATEMENT

The present patent application claims priority to U.S. Provisional Patent Application Ser. No. 62/160,177, filed on May 12, 2015, the entire contents of which is hereby expressly incorporated herein by reference.

### STATEMENT REGARDING FEDERALLY SPONSORED RESEARCH OR DEVELOPMENT

Not applicable.

### BACKGROUND

The development of new materials and sensors through the solution-gelation (sol-gel) process has garnered considerable interest in academia and industry. The broad interest in the sol-gel process stems from the multitude of desirable properties in the resultant materials, including optical transparency, chemical robustness, and mild processing conditions. Moreover, the materials scaffold produced by the sol-gel process has superior versatility yielding many different classes of materials with a range of applications in synthesis, analysis, controlled release technology, protective coatings, adsorption, chromatography, separation, biotechnology, energy conservation, cultural heritage restoration, environmental remediation, and many other fields of contemporary technology.

Chemical functionality and optical properties of sol-gel materials are often tuned through the addition of dopants. Historically, the incorporation of dopants into the sol-gel material has been achieved by two techniques commonly known as pre-doping and post-doping. In pre-doping, the dopant is added to the liquid sol before it is brought to complete gelation (before materials casting or application to a substrate). In post-doping, the dopant is adsorbed onto inner pore surfaces of porous sol-gel substrates long after the completion of the sol-gel process (when the sol-gel thin film has become an alcogel) and after cast materials formation.

However, each of these two conventional doping techniques has significant disadvantages. In the post-doping method, the dopant is introduced to the cast material long after the sol-gel process has completed (when the thin film has converted to an alcogel). Dopants are added by direct physiosorption, or chemical modification of the material surface followed by physiosorption. As a result, the substrate is not sufficiently porous enough to afford high doping efficiency. In the pre-doping method, relatively low concentrations of dopant must be used to prevent structural compromise of the post-gelation material. If high dopant concentrations are used the physical properties of the substrate may be negatively altered. Furthermore, the use of denaturing alcohols in the sol-gel process prior to casting is a major disadvantage of the pre-doping technique for bioactive dopants. Thus, the development of new sol-gel doping methods which overcome the disadvantages of the current techniques is needed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Several embodiments of the presently disclosed inventive concepts are hereby illustrated in the appended drawings. It is to be noted however, that the appended drawings only illustrate several typical embodiments and are therefore not intended to be considered limiting of the scope of the presently disclosed inventive concepts. Further, in the appended drawings, like or identical reference numerals or letters may be used to identify common or similar elements and not all such elements may be so numbered. The figures are not necessarily to scale and certain features and certain views of the figures may be shown as exaggerated in scale or in schematic in the interest of clarity and conciseness.

FIG. 1 is a photograph of a kinetically-doped thin films displayed with variable post spin coating delay (minutes). A post-doped cover slip (CS) without thin film and two pre-doped thin films (with 1 mM and 0.5 mM Rhodamine 6G (R6G) in 10 mM phosphate buffer (pH 7) doping solutions) are presented for comparison. A thin film submerged only in 10 mM phosphate buffer (pH 7) was used as a “Blank” reference and to verify optical quality.

FIG. 2 depicts a schematic cross-sectional view of a thin film submersed in a dopant solution after short post spin coating delay versus a thin film submersed after long post spin coating delay.

FIG. 3 (a) depicts the visible absorption spectrum of R6G from 400 nm to 700 nm plotted for each kinetically-doped thin film and control of FIG. 1, (b) depicts the maximum absorption of the monomer and dimer forms of R6G for each kinetically-doped thin film and control, and (c) depicts the absorption spectra for the longer post spin coating delay samples, post-doped cover slip, and pre-doped thin films, which overlapped significantly in FIG. 3(a).

FIG. 4 is a plot of the film thickness versus R6G absorbance of kinetically-doped thin films. Individual points (circles) are average measurements from multiple spots on a single film. The horizontal line represents the average of all film thickness measurements.

FIG. 5 is a photograph showing several hyper-doped thin films under identically controlled conditions and zero minute post spin coating delay for verification of method reproducibility.

FIG. 6(a) is a photograph of the heat-treated (stored at 65° C.) and non-heat-treated (stored at room temperature) thin films after five days aging. Both had been doped by the presently embodied method prior to aging.

FIG. 6(b) is a photograph of the non-heat-treated film after one hour of extraction in water.

FIG. 6(c) is a photograph of the heat-treated film after one hour of extraction in water.

FIG. 6(d) is a photograph of the non-heat-treated film after one hour of extraction in ethanol.

FIG. 6(e) is a photograph of the heat-treated film after one hour extraction in ethanol.

FIG. 7 depicts an absorption spectrum of a kinetically-doped thin film before and after the heat treatment at 65° C. for 5 days.

FIG. 8 is a photograph of several kinetically-doped thin films with different post spin coating delays (minutes) created in low humidity conditions, where the humidity is below about 20% Relative Humidity (RH).

FIG. 9 is a photograph of several kinetically-doped thin films with different post spin coating delays (minutes) created in medium humidity conditions, where the humidity is between about 30% and about 50% RH.

FIG. 10 is a photograph of several kinetically-doped thin films with different post spin coating delays (minutes) created in high humidity conditions, where the humidity is above about 50% RH.

FIG. 11 is a photograph of kinetically-doped thin films created with (a) a standard spin chuck under low humidity conditions, (b) a standard spin chuck under mid humidity conditions, (c) a standard spin chuck under high humidity conditions, (d) and a high porosity spin chuck under mid humidity conditions.

FIG. 12 is a photograph of several kinetically-doped thin films and cover slip control at varied dopant submersion times (hours). All samples were prepared from a high porosity spin chuck.

FIG. 13 depicts a graph of the R6G monomer and dimer maximum absorbance for each kinetically-doped thin film doped with varied submersion times along with the monomer absorbance for the corresponding post-doped cover slips.

### DETAILED DESCRIPTION

The presently disclosed inventive concepts are directed to, in at least one embodiment, a new kinetically-controlled sol-gel doping method in which a dopant is applied to a sol-gel material during the transition (gelation) phase, rather than before or after the transition phase to an alcogel. This novel and unorthodox approach utilizes the slow reaction kinetics associated with the sol-gel process to dope an evolving sol-gel material. In contrast to pre-doping and post-doping methods, the dopant in the embodiments described herein (the kinetic doping method) is incorporated inside a pristine, rapidly evolving sol-gel layer by exposing (e.g., by submersion) the freshly cast sol-gel (on a substrate) to a dopant solution before it has evolved into a thermodynamically more stable alcogel state. This new approach, also referred to herein for example as a “kinetically-doped method”, yields high doping efficiency relative to either conventional pre-doping methods (dopant added to the sol-gel before application of the sol-gel to a substrate) or conventional post-doping methods (doping the film after it has transitioned into an alcogel thin film on a substrate).

Before describing various embodiments of the presently disclosed inventive concepts in more detail by way of exemplary description, examples, and results, it is to be understood that the presently disclosed inventive concepts are not limited in application to the details of methods and compositions as set forth in the following description. The presently disclosed inventive concepts are capable of other embodiments or of being practiced or carried out in various ways. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that other embodiments of the presently disclosed inventive concepts may be practiced without these specific details. In other instances, features which are well known to persons of ordinary skill in the art have not been described in detail to avoid unnecessary complication of the description.

All of the compositions and methods of production and application thereof disclosed herein can be made and executed without undue experimentation in light of the present disclosure. While the compositions and methods of the presently disclosed inventive concept have been described in terms of particular embodiments, it will be apparent to those of skill in the art that variations may be applied to the compositions and/or methods and in the steps or in the sequence of steps of the method described herein without departing from the concept, spirit and scope of the inventive concepts. All such similar substitutes and modifications apparent to those of skilled in the art are deemed to be within the spirit, scope and concept of the inventive concepts as defined herein.

Unless otherwise defined herein, scientific and technical terms used in connection with the presently disclosed inventive concepts shall have the meanings that are commonly understood by those having ordinary skill in the art. Further, unless otherwise required by context, singular terms shall include pluralities and plural terms shall include the singular. As utilized in accordance with the methods and compositions of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the term “about” is used to indicate that a value includes the inherent variation of error for the composition, the method used to administer the composition, or the variation that exists among the study objects. Further, in this detailed description and the appended claims, each numerical value (e.g., temperature or time) should be read once as modified by the term “about” (unless already expressly so modified), and then read again as not so modified unless otherwise indicated in context. Also, any range listed or described herein (e.g., for percent relative humidity) is intended to include, implicitly or explicitly, any number within the range, particularly all integers, including the end points, and is to be considered as having been so stated. For example, “a range from 1 to 10” is to be read as indicating each possible number, particularly integers, along the continuum between about 1 and about 10. Thus, even if specific data points within the range, or even no data points within the range, are explicitly identified or specifically referred to, it is to be understood that any data points within the range are to be considered to have been specified, and that the inventors possessed knowledge of the entire range and the points within the range.

As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

As noted above, in at least one embodiment, the presently disclosed inventive concepts are directed to a new kinetic doping method in which a dopant is applied to a sol-gel material during the transition phase, rather than before or after the transition phase (when the thin film has transitioned to an alcogel state). This new approach yields high doping efficiency relative to the conventional pre-doping and post-doping methods.

Besides the advantage of high doping efficiency, another advantage of the films and surfaces created by the kinetic doping method is their ability to maintain a high degree of structural integrity without cracking or displaying surface imperfections significant enough to degrade the optical quality of the film surface, even at high doping concentrations. Achieving similar high concentrations of dopant by pre-doping requires very high dopant concentration in the liquid sol, which runs the risk of altering the material structure of the final film surface. Post-doping to the high concentrations achieved using the new kinetic doping method is either unheard of or would require a very porous glass substrate resulting in loss of mechanical rigidity and optical quality. Since the structure of the doped material formed by the kinetic doping method is not significantly altered by the addition of the dopant, the desirable characteristics of the precursor material can be preserved in the final film material. Thus, the kinetic doping method enables the production of mechanically rigid thin films with high optical quality.

Moreover, by doping to an evolving sol-gel material in the kinetic doping method, the exposure of dopant to denaturing alcohols encountered in pre-doping can be dramatically reduced. In certain embodiments of the presently disclosed kinetic doping method, loading into a freshly formed (pristine) silica sol-gel surface during its evolution stage allows a dopant molecule to be loaded under a more benign (non-denaturing) environment where alcohol is mostly absent. The use of a phosphate buffer during doping enables use of a wide range of sensitive biomolecules as well. Under a benign, non-denaturing environment, the use of biological molecules (e.g., proteins) as the dopant becomes possible.

The relatively low cost, high doping efficiency, benign conditions, ease of implementation, and other advantages make this new method enticing to a wide range of sol-gel applications, including, but not limited to, the development of sensors with biomolecules, anti-fouling coating, and dye-sensitized solar cells.

The precursor materials used to make the sol-gels of the presently disclosed inventive concepts can be any suitable sol-gel material of inorganic composition or inorganic/organic composition. Suitable precursor materials include, but are not limited to, tetramethoxysilane (TMOS), tetraethoxysilane (TEOS), fluoroalkoxysilane, chloroalkoxysilane, germanium alkoxides, vanadium alkoxides, aluminum alkoxides, zirconium alkoxides, titanium alkoxides, silica, titania, zirconia, vanadia, niobium oxide, tantalum oxide, tungsten oxide, tin oxide, hafnium oxide and alumina, or mixtures or composites thereof, having reactive metal oxides, alkoxides, halides, amines, etc. capable of reacting to form a sol-gel.

The solvent used in the methods of the presently disclosed inventive concepts can be any suitable organic solvent including, but not limited to, methanol, ethanol, n-propanol, isopropyl alcohol, ethylene glycol, polyethylene glycol, and other forms of alcohol that facilitate the formation of a single layer of liquid precursor sol solution.

The precursor material can be applied to the material scaffold (substrate) by any suitable coating process, including, but not limited to, spin coating, dip coating, and spray coating.

The term “alcogel” where used herein refers to the state wherein the wet hydrogel has transitioned to a state wherein the hydrolysis and condensation reactions in the sol-gel have been substantially completed (e.g., about 95%) such that the sol-gel has a substantially stable size and shape. For example, when the sol-gel is applied to a substrate under medium humidity conditions (e.g., 30% to 50% RH), the sol-gel in ambient air will reach the alcogel state within at least about 10 minutes. The term “pristine” when used in reference to a sol-gel thin film refers to a sol-gel film freshly applied to a substrate and which exhibits high doping efficiency without noticeable mechanical or optical degradation and which has not transitioned to the alcogel state.

In general, any coating thickness can be applied to the materials scaffold. The coating can have a thickness in the range of, but not limited to, 1 nm to 10 μm, for example 1 nm to 5 μm, 5 nm to 1 μm, 1 nm to 500 nm, 100 nm to 300 nm, 2 nm to 5 μm, or any sub-range of integers or fractions inclusive within the range 1 nm to 10 μm, including, but not limited to a range including 1 nm, 2 nm, 3 nm, 4 nm, 5 nm, 6 nm, 7 nm, 8 nm, 9 nm, 10 nm, 11 nm, 12 nm, 13 nm, 14 nm, 15 nm, 25 nm, 50 nm, 100 nm, 200 nm, 300 nm, 400 nm, 500 nm, 600 nm, 700 nm, 800 nm, 900 nm, 1 μm, 2 μm, 3 μm, 4 μm, 5 μm, 6 μm, 7 μm, 8 μm, 9 μm, and 10 μm.

In the methods of the presently disclosed inventive concepts the sol-gel materials can be applied to various forms and substrates including, but not limited to, monoliths, coated materials, porous membranes, disks, rods, wafers, fibers, powders, nanoparticles, microparticles, microcapsules, flat surfaces of glass, silicon, silicon dioxide, metals, inner and/or outer surfaces of tubes and/or capillaries, and porous materials such as molecular sieves and zeolites. The dopant(s) applied using the methods of the presently disclosed inventive concepts can be any suitable dopant known to those having ordinary skill in the art, including, but not limited to, dyes, biomolecules, organometallics, pharmaceutical drugs, catalysts, biocides, corrosion inhibitors, antibodies, antigens, peptides, sensing species, oils, waxes, organic liquids, aromatic compounds, flavorings, fragrances, polymers, electrolytes, metals, and metallic compounds. Suitable dopants may include, without limitation, rhodamine 6G (R6G), pyrene, avobenzone, nitrobenzene, formamide, citronella, dimethylphtalate, eucalyptol, camphor, menthol, heparin, dopamine, insulin, nifedipine, toremifene citrate, bisphosphonate, biotin, horseradish peroxide, glucose oxidase, luciferase, zinc pyrithione, benzotriazole, cerium(III) salicylate, cerium nitrate, iron, nickel, copper, cobalt, silver, gold, palladium, chromium, neodymium, erbium, thulium, ytterbium, boron, aluminum, gallium, indium, arsenic, phosphorus, antimony, iron oxide, copper nitride, and gallium nitride.

In at least one embodiment, the presently disclosed inventive concepts include, but are not limited to, a sol-gel method of forming a doped thin film material, comprising (a) providing a liquid sol solution in a wet state, (b) applying the liquid sol solution to a substrate surface to form a pristine sol-gel thin film on the substrate surface, (c) aging the pristine sol-gel thin film forming an aged sol-gel thin film, and (d) converting the aged sol-gel thin film on the substrate surface into a hydrogel by exposing the aged sol-gel thin film to a dopant solution comprising a dopant before the aged sol-gel thin film changes to an alcogel state in ambient air, wherein the dopant is taken up by the hydrogel to form the doped thin film material, the doped thin film material having a dopant concentration that is at least 100% greater than that obtained in a thin film in the alcogel state when it is exposed to the dopant solution. The step of applying the liquid sol solution to the substrate surface and aging the pristine sol-gel thin film to form the aged sol-gel thin film may occur under a relative humidity (RH) condition of about 1% RH to less than about 50% RH, and the step of aging the pristine sol-gel thin film on the substrate surface may occur within a range of about 5 seconds to about 7 minutes. The step of applying the liquid sol solution to the substrate surface and aging the pristine sol-gel thin film to form the aged sol-gel thin film may occur under a relative humidity (RH) condition of about 50% RH to about 100% RH, and the step of aging the pristine sol-gel thin film on the substrate surface may occur within a range of about 5 seconds to about 60 minutes. The step of exposing the pristine sol-gel thin film to the dopant solution may occur by submerging the pristine sol-gel thin film into the dopant solution. The dopant concentration in the doped thin film material may be at least 1000% greater than that obtained in a thin film in the alcogel state when it is exposed to the dopant solution. In at least one embodiment the alcogel state is defined as a state of hydrolysis-condensation reached by the sol-gel thin film after 10 minutes when the liquid sol solution is applied to the substrate under 30% to 50% RH.

The dopant concentration in the doped thin film material may be at least 250%, at least 500% greater, at least 750%, at least 1000%, at least 2000% greater, at least 3000%, at least 4000% greater, at least 5000%, at least 6000% greater, at least 7000%, at least 8000% greater, at least 9000%, at least 10000% greater, at least 11000%, at least 12000% greater, at least 13000%, at least 14000% greater, at least 15000%, at least 16000% greater, at least 17000%, at least 18000% greater, at least 19000%, at least 20000% greater, at least 21000%, at least 22000% greater, at least 23000%, at least 24000% greater, at least 25000%, at least 26000% greater, at least 27000%, at least 28000% greater, at least 29000%, or at least 30000% greater than that obtained in a thin film in the alcogel state when it is exposed to the dopant solution.

### EXAMPLES

The presently disclosed inventive concepts, having now been generally described, will be more readily understood by reference to the following examples and embodiments, which are included merely for purposes of illustration of certain aspects and embodiments of the presently disclosed inventive concepts, and are not intended to be limiting. The following detailed examples of the presently disclosed inventive concepts and are to be construed, as noted above, only as illustrative, and not as limitations of the disclosure in any way whatsoever. Those skilled in the art will promptly recognize appropriate variations from the various compositions, structures, components, procedures and methods.

### Example 1

### Effect of Delay Before Submersion of Sol-Gel Coated Substrate into Dopant Solution

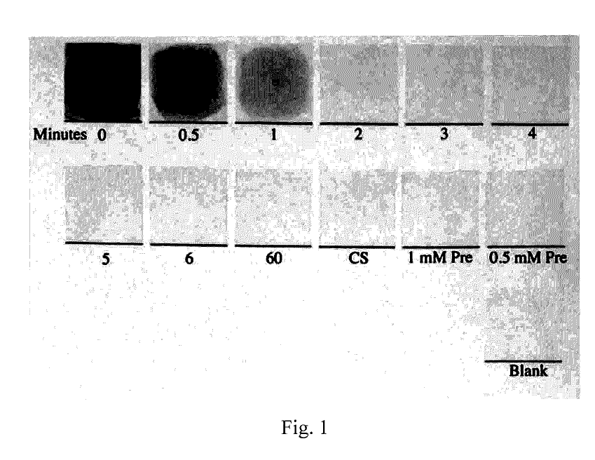

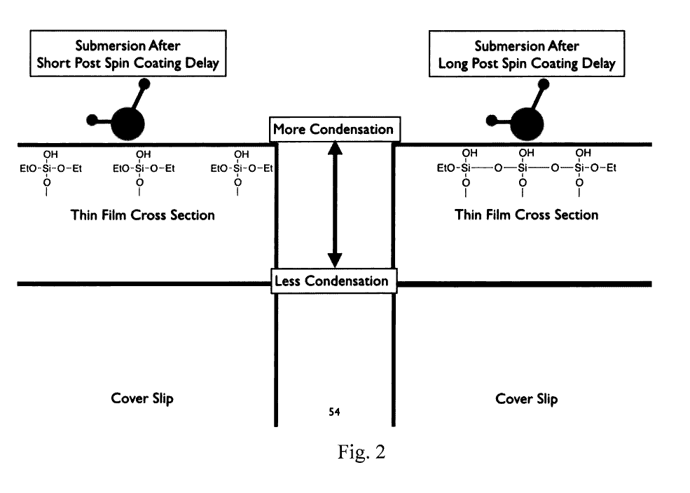

In at least one embodiment of the presently disclosed inventive concepts, the kinetic doping method was used to apply a dopant, Rhodamine 6G (R6G), to a freshly spun-cast silica thin film before the thin film evolved into a thermodynamically more stable alcogel film (as explained below, other dopants can be used in the methods of the presently disclosed inventive concepts). Utilizing the alkoxide hydrolysis pathway, a TEOS/ethanol/water/1% H₃PO₄ sol was prepared and allowed to age for 18-20 hours (other durations of time, <18 hrs or >20 hrs, for aging the sol can be used). During the aging time, the sol was undergoing simultaneous hydrolysis and poly-condensation reactions. The properly aged sol was then spin coated into thin films on a substrate. During the spin coating process, physical properties of the resultant films were rapidly evolving and were extremely sensitive to influences from alcohol evaporation, reaction with air moisture (relative humidity), airflow dynamics, thermal conductivity, and spin chuck specifications (as discussed further below). In contrast to pre-doping and post-doping methods, R6G in the kinetically-doped approach was incorporated inside rapidly evolving pristine thin films in this example by submerging the film-bearing substrates into a dopant solution containing 1.0 mM R6G in 10 mM phosphate buffer (pH 7). After a preset post spin coating delays (PSCD) ranging from 0 to 60 minutes (indicated in FIG. 1), the films were submerged in the dopant solution for 1 hour and then removed from solution, rinsed with deionized water, and blown dry. R6G uptake by the resultant film varied systematically with the PSCD prior to submersion in the dopant solution (FIG. 1).

As a control, a clean cover slip was post-doped with the same R6G buffer solution for the same amount of time as the kinetically doped films were. Other controls included 1 mM and 0.5 mM R6G pre-doped samples where R6G was added to the liquid sol (i.e., pre-doped) and mixed immediately before spin coating.

The observed trend was a decrease in doping from zero to sixty minutes PSCD. Visual inspection of the pink R6G color indicates that the kinetically-doped film with zero minute PSCD lead to significantly more R6G uptake. The loading of these kinetically-doped films quickly diminished and plateaued shortly after two minutes PSCD. Doping with two minutes PSCD or longer appears to be comparable to that of the pre-doped 1 mM and post-doped coverslip controls. At sixty minutes PSCD, the doping mimicked that of a hard glass cover slip. The observed trend is correlated with the known silica sol-gel chemistry where hydrogel gradually condenses and collapses into a hard alcogel upon aging, thus suggesting some property of the hydrogel-like thin film has favorable adsorption of R6G. Thin films with long PSCD are expected to be more alcogel-like, hence exhibiting a similar R6G doping level to that of a plain glass coverslip.

Data supports a model in which the unreacted inorganic precursor in a pristine sol-gel film reacts with water to produce silanols during the submersion stage. The presence of silanols facilitates loading of R6G. The loading diminishes concomitantly with subsequent condensation of the silanols forming the polymeric backbone of the alcogel thin film (FIG. 2).

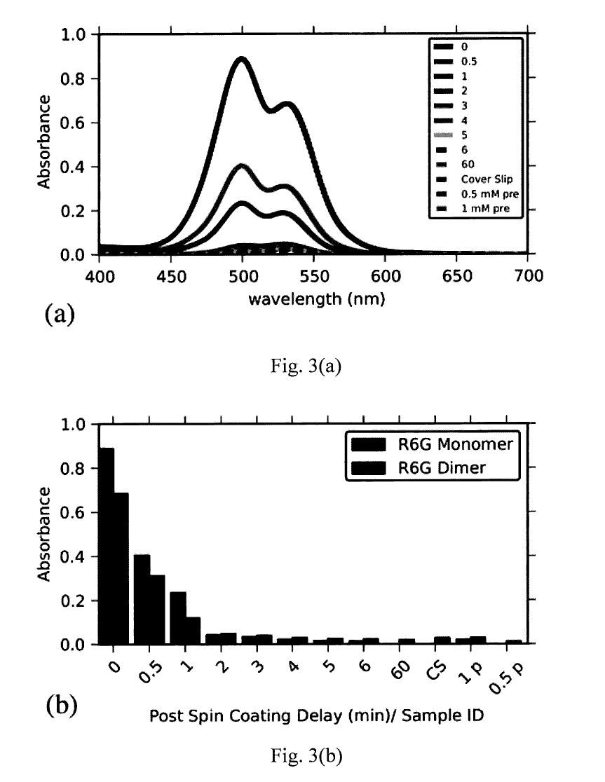

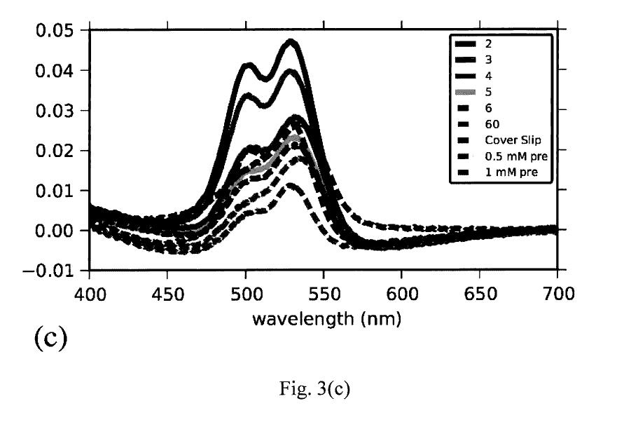

The doping efficiency of the kinetically-doped thin films was quantified by absorption spectroscopy. Absorption spectra were recorded from 400 nm to 700 nm by placing the R6G-doped thin films in the sample path of a dual beam spectrophotometer. The absorption spectra of the thin films exhibit characteristic absorption bands of R6G and its dimer (FIG. 3(a-c)). In the zero minute PSCD kinetically-doped thin film, the R6G monomer maximum absorbance is 0.68 at 531 nm (reported to vary from 526 nm to 534 nm) and the dimer maximum absorbance is 0.89 at about 500 nm (FIG. 3a). As PSCD increases, the maximum absorbance decreases. The rapid decrease in kinetic doping results in many spectra overlapping in FIG. 3(a) at longer PSCD. FIG. 3(c) shows a magnified view of the spectra for the longer PSCD samples (2 min-60 min). The absorbance values for the monomer and dimer are plotted versus PSCD in FIG. 3(b). In accordance with visual inspection of the thin films, the absorption spectra show that the kinetic doping decays rapidly until it plateaus at a relatively constant monomer absorbance of approximately 0.02. This represents the minimum value for kinetic doping which is comparable to the absorbance of approximately 0.03 observed in the 1 mM pre-doped and 0.5 mM pre-doped controls. In comparison, both monomer and dimer absorption from the zero minute PSCD sample are more than one order of magnitude greater than the two pre-doped controls. The presence of the dimer absorption at zero minute PSCD suggests an even greater R6G loading differential between zero minute PSCD and the pre-doping controls, which lends more support to the merit of the presently disclosed kinetic doping method. As the absorption of the kinetically-doped films decreases, the spectra also display a shift in the relative population of R6G monomer and dimers. The population of the dimer decreases with increasing PSCD, and after a four minute PSCD little dimer absorbance remained. No trace of dimer absorbance was observed when PSCD reached 60 minutes. The remaining shoulder seen at −500 nm at long PSCD resembles more the vibronic peak often seen in the spectrum of R6G monomer. The decrease in R6G dimer population could be a direct result of shrinking pore volume and decreasing water content in the resultant more alcogel-like film as PSCD increases. The alcogel-like film with long PSCD (e.g., 60 minutes) is expected to resemble closely the doping behavior of an alcogel, which conveniently represents a post-doped control for the experiment.

An approximation of the relative increase in R6G loading was made by using the ratio of total monomer units in the kinetically-doped film versus the pre-doped 0.5 mM control. The calculation is simplified since no dimer absorbance is observed in the 0.5 mM pre-doped control, and thus only aggregation in the kinetically-doped films must be taken into account. Furthermore, while the thickness undoubtedly shrinks as the films age, the ratio of loading should depend only on the absolute amount of R6G trapped. As no leaching is possible once the films were removed from the R6G loading buffer, the relative amount of R6G loading should remain static. Using the relative absorbance values in this manner with the estimated extinction coefficients for the R6G monomer and dimer in aqueous solution, the calculations show the new kinetically-doped method yielded a 146-fold increase in R6G doping relative to the conventional pre-doping method. This large increase in doping is consistent with the more qualitative visual inspection of the kinetically-doped thin films with variable PSCD shown in FIG. 1.

### Example 2

### Dopant Loading Vs. Film Thickness

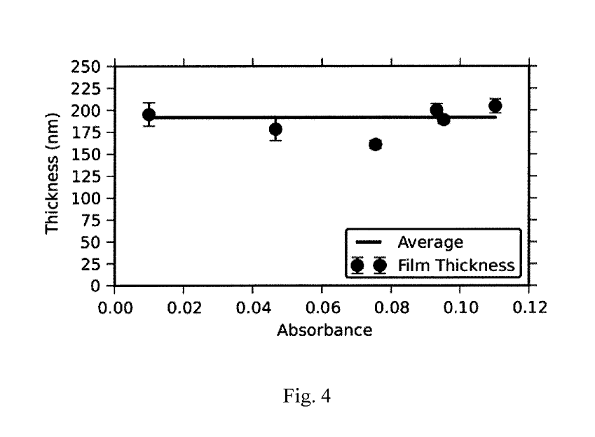

The thickness for similarly prepared samples with different PSCD, and thus different degrees of R6G doping, was measured by profilometry. FIG. 4 illustrates that film thickness did not display any significant correlation with R6G absorbance, which is equivalent to the degree of doping, over a range of one decade difference in loading efficiency. The average thickness for all samples was determined to be 190±10 nm and is represented by the horizontal line in FIG. 4. The lack of significant thickness variation supports the observation that these kinetically-doped films are structurally very similar regardless of loading efficiency. As a reference, the thickness of an alcogel film was measured and determined to be 185±3 nm. This thickness is within the standard deviation of the thickness of the kinetically-doped films, supporting the idea that all kinetically-doped films eventually evolve into alcogel. The lack of correlation between film thickness and dopant concentration suggests that the enhanced dopant content is not a result of a thicker film, but is due to the nature of doping during the transition phase of thin film evolution which occurs as a result of the presently disclosed kinetic doping method.

Using the film thickness as the optical path length in an absorbance measurement, the estimated concentration of R6G monomer units in a film was calculated. In the zero minutes PSCD kinetically doped film, which exhibited the highest doping, the concentration was determined to be approximately 1100 mM. Though the films may further shrink upon normal aging or subjecting to thermal treatment to accelerate aging, the enhanced doping from this method does not change. The ability to produce films with large dopant concentrations would be useful in applications such as dye-sensitized solar cells.

### Example 3

### Sensitivity to Conditions

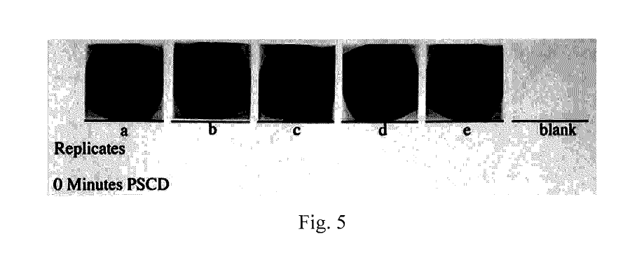

During reproducibility testing, it was observed that the kinetic doping technique is sensitive to several parameters, including PSCD, relative humidity, thermal conductivity on the coverslip during spin coating, and the charge of a dopant. In one example (FIG. 5) using strict control of experimental conditions (zero minute PSCD, 50-51% relative humidity, 74° F.), optical quality films hyper-doped with R6G were prepared reproducibly. The loading was precise as indicated by the average absorbance values for the R6G monomer and dimer, calculated as 0.67±0.04 and 0.85±0.06 respectively.

### Example 4

### Effect of Heating on Dopant Leaching from Films

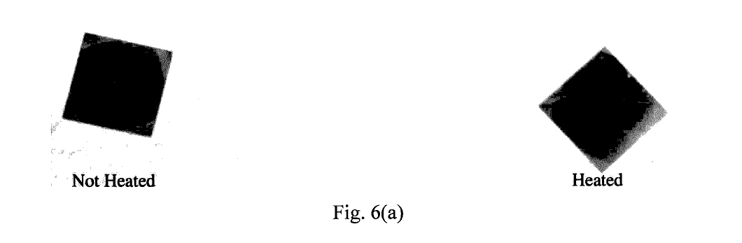

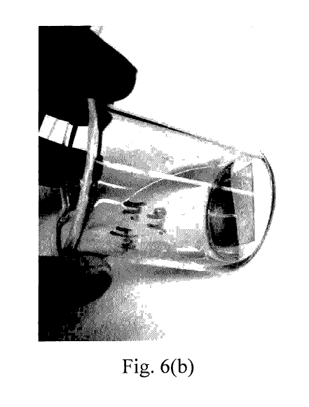

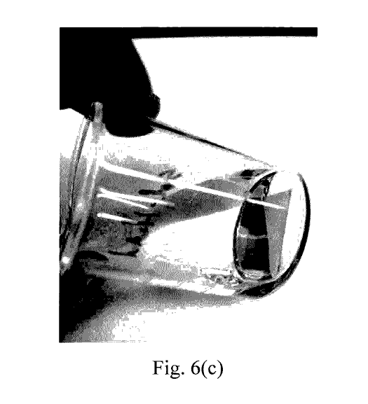

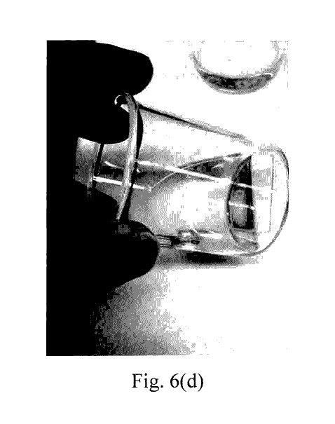

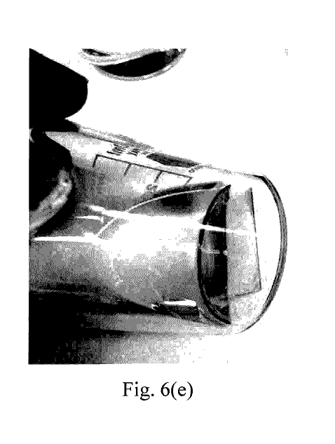

Leaching tests on heated and non-heated, aged thin kinetically-doped films show that kinetically-doped films exhibit minimal R6G leaching when submerged in water (FIG. 6(a-e)). FIG. 6(a) shows heated and non-heated thin films after five days aging. Both had been doped by the presently embodied method prior to aging. FIG. 6(b) shows the non-heated film after one hour of extraction in water. FIG. 6(c) shows the heated film after one hour of extraction in water. FIG. 6(d) shows the non-heated film after one hour of extraction in ethanol. FIG. 6(e) shows the heated film after one hour extraction in ethanol. After one hour of submersion in water, little leaching is observed and the majority of the R6G remains trapped. On the other hand, R6G can be efficiently extracted from hyper-doped films by ethanol, which suggests that there is a network of channels throughout the entire film for molecules of appropriate size to diffuse readily in an appropriate solvent.

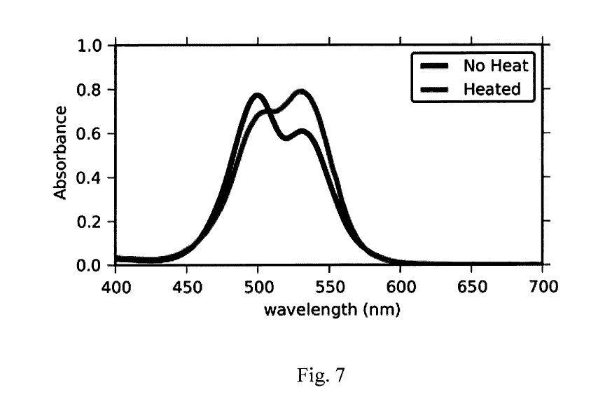

Heating of a kinetically-doped thin film at 65° C. for five days was performed to accelerate aging to the thermodynamically more stable alcogel film. Absorption measurements indicate that there was a significant conversion of the R6G dimer to the monomeric form in the heat-treated sample (FIG. 7). This is likely due to losing water, which is critical for dimer formation. Moreover, shrinkage of pore volume in a heat-treated sample is expected to reduce space available to accommodate R6G dimers. Extraction with water was very slow and leaching was insignificant. Subsequent extraction with ethanol showed considerably more leaching, but much less than those from the non-heat treated films. Despite further attempts to extract, some R6G remained in the thin films. This observation is likely attributed to significant shrinkage of pore volume in the thin film, which renders a portion of R6G inaccessible such that it becomes permanently trapped.

### Example 5

### Effect of Relative Humidity

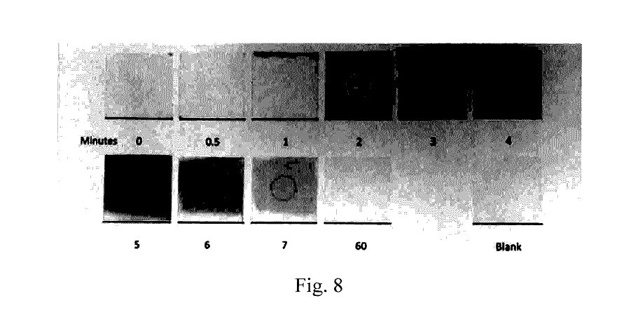

In low humidity conditions (e.g., below 20% RH, the low PSCD thin films (PSCD=0-1 min) had minimal loading (FIG. 8). During submersion, these samples were actually losing parts of the thin films. Visible flakes of the thin films could be seen floating in solution under close inspection. However, the thin films that remained attached to the cover slip doped rather well. This observation suggests that at low PSCD the thin films were not structurally rigid from lack of extensive polycondensation reaction. As observed in the two minute PSCD thin film in FIG. 8, the portion of the film that remains attached to the cover slip does begin to dope. After three minutes PSCD, optimal doping is achieved, and the doping is rather homogenous. Allowing the films to mature further resulted in a decreasing trend for doping. With PSCD longer than 7 min, little doping was observed, and no visibly observable doping was present after sixty minutes PSCD.

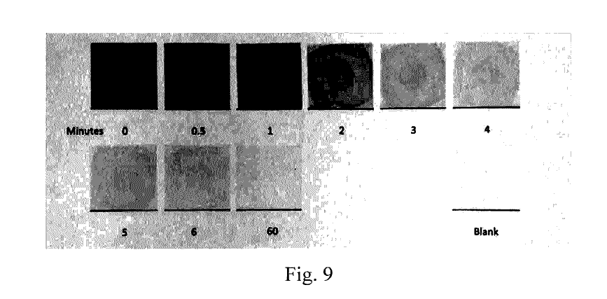

Increasing the relative humidity to approximately 50% (i.e., within a mid-humidity range of about 30% to about 50%) results in peak loading occurring at zero minutes PSCD (FIG. 9). In the low PSCD thin films (PSCD=0-1 min), the films do not peel off from the cover slip (unlike under low humidity), and the films exhibit high doping efficiency without noticeable mechanical or optical degradation (referred to herein as “pristine” quality). The increase in relative humidity effectively decreased the requirement of a PSCD for pristine films and slightly broadened the window for hyper-doping. The increase in thin film mechanical compliance at conditions of 50% humidity suggests that water vapor in the air causes the films to mature, and become mechanically compliant, faster. The increase in water vapor is likely hydrolyzing-off unreacted alkoxy groups which subsequently polycondense to form the more rigid 3-D network.

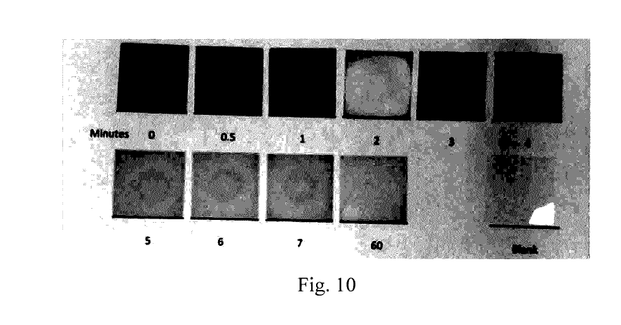

Elevating the humidity to high humidity conditions (e.g., above about 60% RH) showed similar results as mid humidity conditions but with a broadening of the PSCD conditions that rendered pristine films (FIG. 10). Under these elevated humidity conditions, doping at zero minute delay remained optimum, but high concentrations of dopants were observed from films with PSCD as long as four minutes and some noticeable doping still occurred even at 60 min PSCD.

### Example 6

### Effects of Spin Chuck Used in Spin Coating

A spin coater uses vacuum to hold a substrate in place during the spin coating process. In a standard spin chuck, the vacuum is delivered through the center of the spin chuck via a 6 mm diameter channel. This configuration tends to lead to an uneven pulling force that is substantially concentrated at the center, making the center of a thin substrate slightly bend and produce a film of less-even thickness. In a high porosity spin chuck, the center vacuum channel does not reach a substrate directly. Instead, the vacuum channel branched into an array of 6×6 smaller region on a 22×22 mm² flat surface. Within each small region, there are tens of micro-channels that connect directly to the center vacuum channel. A substrate placed on top of the 22×22 mm² flat surface will be firmly held by vacuum through the micro-channels that are populating each small region of the 6×6 array. This configuration leads to a more even pulling force that is completely distributed across the 22×22 mm² spin chuck surface, enabling a thin substrate to stay flat and produce a film of even thickness.

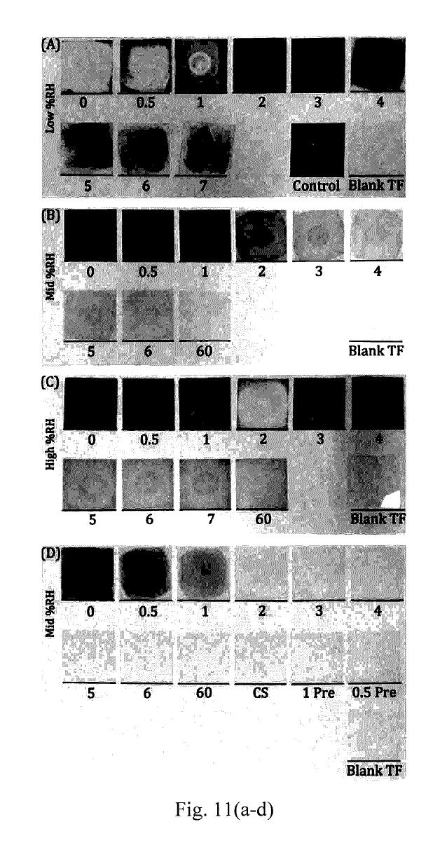

Variation of the spin chuck on the spin coater provided further insight into the effect of thermal conductivity which affects film structure and subsequently influence doping efficiency. Using the original chuck where a glass coverslip substrate is only in contact with a rubber o-ring that circles the central vacuum channel, the film doping varied with film structure (FIGS. 11(a-c)). In regions where there is no underneath support, the film is believed to be thinner and doped earlier. In regions where the coverslip is supported by the o-ring, the film is believed to be thicker and optimal doping was delayed, suggesting that the reaction with ambient water vapor took longer in the thicker regions. This observation was especially obvious in thin films prepared under low humidity (e.g., <20% RH) conditions in FIG. 11(a) where a prominent circle that represents the location supported by the o-ring can be easily observed. Films have greater homogeneity were achieved (FIG. 11 (d)) using a high porosity spin chuck, which was used in the remainder of the studies. With a high porosity spin chuck, 75% of a glass coverslip substrate is evenly supported, providing fairly even thermal conductivity over a large area of a thin film. This help produces a pristine film with high structural homogeneity, hence a more homogeneous doping over a large area of the pristine film.

### Example 7

### Effect of Submersion Time

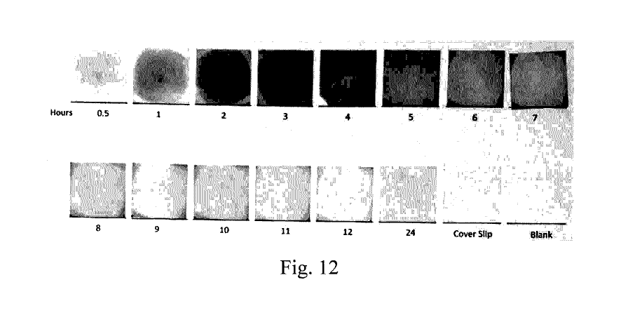

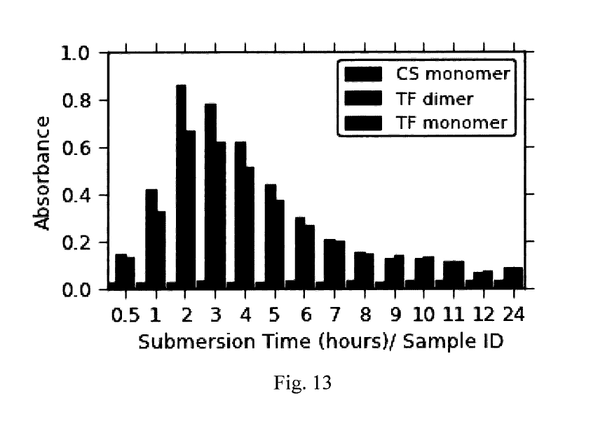

Varying the submersion time of the PSCD thin films in the dopant solution (0.5-24 hr) resulted in a Boltzmann-like adsorption isotherm (FIGS. 12 and 13). A submersion time on a range of approximately 2-3 hours resulted in the highest doping and adsorption at ˜50% RH. Without wishing to be bound by theory, it is believed that the pristine film continues to evolve while doping is in progress.

### Example 8

### Preparation of the Sol-Gel

In at least one embodiment of the presently disclosed inventive concepts, the sol-gel used in the kinetic doping method was prepared as described below:

Substrate Preparation

To a cover slip (e.g., 25×25 mm Fisherfinest Premium Cover Glass) apply one acetone wash, five Millipore water rinses, one 10% NaOH wash, and another five Millipore water rinses. During each washing step, sonicate the cover slip in the wash solution for 30 minutes. On the fifth Millipore water rinse, sonicate the cover slip for 5 minutes prior to the next washing step. Store the cover slip in Millipore water until used.

Sol-Gel Preparation

(1) In a 1.5 mL microcentrifuge tube, combine 633.8 pL ethanol (e.g., 95% Pharmco-Aaper), 317.5 μL tetraethyl orthosilicate (TEOS) (e.g., 99.999% Aldrich), 180 μL Millipore water (e.g., 17.7 MΩ or above), and 3.51 pL 1% H₃PO₄ (e.g., 85% EMD). The sol mixture is thoroughly mixed with a vortex mixer (e.g., VWR), tightly seal, and then store in the dark to let it age (e.g., for 18-20 hours).

(2) After the 18-20 hours of allotted aging time, the aged liquid sol is thoroughly mixed again with a vortex mixer. Any silica colloid formed during aging is forced to the bottom of the micro centrifuge tube with a mini-centrifuge (e.g., VWR). Only the colloid-free supernatant will be used in the spin coating process to produce thin silica sol-gel films. Using a micropipette, 80 μL of the aged liquid sol is transferred onto the cover slip substrate and spun coated into a pristine thin film at 6100 rpm for 70 seconds using a spin coater (e.g., Laurell Technologies Model WS-400A-6NPP/LITE).

(3) After a predetermined PSCD, the newly formed pristine thin film is submerged into a dopant solution consisting of 1.0 mM R6G in 10 mM phosphate buffer (pH 7) for 1 hour to commence doping. After one hour of doping, the thin film is removed from the dopant solution, rinsed with deionized water, and blown dry by compressed air.

(4) In an alternative experimental design to achieve maximum doping (FIGS. 12 and 13), the optimal timing for removing the sol-gel material from the doping solution can be monitored in real time by spectroscopic method.

It will be understood from the foregoing description that various modifications and changes may be made in the various embodiments of the present disclosure without departing from their true spirit. For example, the kinetically controlled doping method can be performed on a variety of inorganic oxide sol-gel thin films prepared in a variety of manners, with various thicknesses of materials and layers, and doped with various additives and dopant materials. The description provided herein is intended for purposes of illustration only and is not intended to be construed in a limiting sense. Thus, while the presently disclosed inventive concepts have been described herein in connection with certain embodiments so that aspects thereof may be more fully understood and appreciated, it is not intended that the presently disclosed inventive concepts be limited to these particular embodiments. On the contrary, it is intended that all alternatives, modifications and equivalents are included within the scope of the presently disclosed inventive concepts as defined herein. Thus the examples described above, which include particular embodiments, will serve to illustrate the practice of the presently disclosed inventive concepts, it being understood that the particulars shown are by way of example and for purposes of illustrative discussion of particular embodiments of the presently disclosed inventive concepts only and are presented in the cause of providing what is believed to be a useful and readily understood description of procedures as well as of the principles and conceptual aspects of the inventive concepts. Changes may be made in the formulation of the various components and compositions described herein, the methods described herein or in the steps or the sequence of steps of the methods described herein without departing from the spirit and scope of the presently disclosed inventive concepts. All patents, published patent applications, and non-patent publications referenced in any portion of this application are herein expressly incorporated by reference in their entirety to the same extent as if each individual patent or publication was specifically and individually indicated to be incorporated by reference.

What is claimed is:

1. A sol-gel method of forming a doped thin film material, comprising:
providing a liquid sol solution in a wet state;
applying the liquid sol solution to a substrate surface to form a pristine sol-gel thin film on the substrate surface;
aging the pristine sol-gel thin film forming an aged sol-gel thin film; and
converting the aged sol-gel thin film on the substrate surface into a hydrogel by exposing the aged sol-gel thin film to a dopant solution comprising a dopant before the aged sol-gel thin film changes to an alcogel state in ambient air, wherein the dopant is taken up by the hydrogel to form the doped thin film material, the doped thin film material having a dopant concentration that is at least 100% greater than that obtained in a thin film in the alcogel state when it is exposed to the dopant solution.

2. The method of claim 1, wherein the step of applying the liquid sol solution to the substrate surface and aging the pristine sol-gel thin film to form the aged sol-gel thin film occurs under a relative humidity (RH) condition of about 1% RH to less than about 50% RH, and the step of aging the pristine sol-gel thin film on the substrate surface occurs within a range of about 5 seconds to about 7 minutes.

3. The method of claim 1, wherein the step of applying the liquid sol solution to the substrate surface and aging the pristine sol-gel thin film to form the aged sol-gel thin film occurs under a relative humidity (RH) condition of about 50% RH to about 100% RH, and the step of aging the pristine sol-gel thin film on the substrate surface occurs within a range of about 5 seconds to about 60 minutes.

4. The method of claim 1, wherein the step of exposing the aged sol-gel thin film to the dopant solution occurs by submerging the aged sol-gel thin film into the dopant solution.

5. The method of claim 1, wherein the dopant concentration in the doped thin film material is at least 1000% greater than that obtained in a thin film in the alcogel state when it is exposed to the dopant solution.

6. The method of claim 1, wherein the alcogel state is defined as a state of hydrolysis-condensation reached by the sol-gel thin film after 10 minutes when the liquid sol solution is applied to the substrate under 30% RH to 50% RH.
